(19) United States
(12) Patent Application Publication
(10) Pub. No.: US 2009/0313618 A1
(43) Pub. Date: Dec. 17, 2009

(54) INFORMATION PROCESSING APPARATUS, CONTROL METHOD THEREFOR, STORAGE MEDIUM STORING CONTROL PROGRAM THEREFOR, IMAGE PROCESSING APPARATUS, CONTROL METHOD THEREFOR, AND STORAGE MEDIUM STORING CONTROL PROGRAM THEREFOR

(75) Inventor: Toshio Sakurai, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/480,849

(22) Filed: Jun. 9, 2009

(30) Foreign Application Priority Data
Jun. 17, 2008 (JP) 2008-157861

(51) Int. Cl. G06F 9/445

(52) U.S. Cl. 717/174; 719/327

(57) ABSTRACT

An information processing apparatus capable of easing a setup of an alternative apparatus on execution of alternative printing function. An installation unit installs driver software corresponding to a first image processing apparatus on the information processing apparatus. A collection unit collects information about a second image processing apparatus corresponding to other driver software that has been already installed on the information processing apparatus when the driver software is installed by the installation unit. A transmission unit transmits the information collected by the collection unit to the first image processing apparatus.

### BACKGROUND OF THE INVENTION

1. Field of the Invention

The present invention relates to an information processing apparatus such as a host PC (personal computer), a control method therefor, a storage medium storing control program therefor, an image processing apparatus (an image output apparatus) such as a multifunction printer connected to the information processing apparatus, a control method therefor, and a storage medium storing control program therefor.

2. Description of the Related Art

A multifunction printer (referred to as MFP hereinafter), which is a single apparatus having functions of a copier, a facsimile machine, a printer or the like, is one of peripheral devices connected to a PC. An MFP is provided with at least two functions chosen from among a printer function, a facsimile function, and a copy function. There are various combinations of these functions.

A PC is not only connected to a peripheral device directly, but can be connected to a plurality of peripheral devices through a network such as a LAN. For example, when a printer is connected to a PC as a peripheral device, a printer driver installed on the PC causes the printer to execute printing.

The printer driver installed on the PC collects functions and operation condition of a corresponding printer via a network from the printer. The collected information is used, for example, to select a printer and to set possible functions.

A recent MFP can cooperate to other printers so as to execute coordination operation, such as an alternative print function.

An alternative print function means the function to share a print job, which is usually completed by a single MFP, with other printers that are connected via a network.

A remote copy operation in which an MFP scans a document and causes another printer that is connected via a network to print a copy of the scanned document is an example of the alternative print function.

A usual copy operation outputs a copy of the scanned document using a printer unit of the MFP that scanned the document. On the other hand, when the printer unit of the MFP that scanned the document cannot operate due to a paper-out trouble etc. or when the print function that is not provided with the MFP that scanned the document is required, the alternative printing function is executed. The alternative print function is applicable to not only a copy operation but also a facsimile operation etc.

An MFP that substitutes data transmission/data reception is connected to a network that is common to a substituted MFP. A PC is also connected to the common network and the MFP can print the data sent from the PC.

When printing the data sent from the PC, the PC always sends the print data to the MFP via the network. In alternative printing, the MFP directly sends the print data to another printer via the network without passing through the PC.

Since the alternative printing is performed by passing the PC on the network, the alternative printing must be able to be set up by an MFP separately.

Conventionally, to connect a plurality of printers to a network, a print server is provided in the network. Print data transmitted from a host PC is once stored in the print server and is distributed to respective printers.

The print server records all the operations including alternative printing operations of the respective printers used in the network. Japanese laid-open patent publication (Kokai) No. 2000-197165 (JP2000-197165A) discloses the technique of simplifying a setup of an MFP that performs alternative printing based on the recorded information.

Japanese laid-open patent publication (Kokai) No. 2002-160426 (JP 2002-160426A) discloses the technique of transmitting print data from an MFP to another printer that can perform alternative printing to carry out remote copy without using a print server.

In alternative printing, an output destination must be set by some method. In alternative printing, since the output destination is changed from an MFP as an original output destination to another printer, it is desirable that a user can set an alternative output destination on the MFP of the original output destination.

However, a user interface (UI) of an MFP is insufficient as compared with that of a PC from viewpoints of cost and need.

In addition, although a printer is identified by an IP address on a TCP/IP network for example, an IP address does not include location information about an actual installation of a printer and information about functions of an MFP.

Accordingly, to specify an alternative device (printer) by an IP address, a user is required to check an IP address of the printer that alternatively prints, and then to define the IP address checked in the MFP to which alternative printing is set.

Although printers that can alternatively print can be displayed in a list on the control panel of MFP, when many printers exist on a network, it is difficult to find out a desirable printer from many candidates.

Although the above-mentioned Japanese laid-open patent publication (Kokai) No. 2000-197165 (JP2000-197165A) discloses a technique of selecting a printer easily, the technique absolutely needs the desirable print server that manages printers in a network.

Since the network disclosed in Japanese laid-open patent publication (Kokai) No. 2000-197165 (JP2000-197165A) does not have a print server for recording information about an MFP that can perform alternative printing, an MFP that can perform alternative printing must be selected from a list displayed on a UI of an MFP.

### SUMMARY OF THE INVENTION

The present invention provides an information processing apparatus, a control method therefore, a storage medium storing a control program therefore, an image processing apparatus, a control method therefore, and a storage medium storing a control program therefore that are capable of easing a setup of an alternative apparatus (an image processing apparatus) on execution of alternative printing function.

Accordingly, a first aspect of the present invention provides an information processing apparatus including an installation unit adapted to install driver software corresponding to a first image processing apparatus on the information processing apparatus, a collection unit adapted to collect information about a second image processing apparatus corresponding to another driver software that has been already installed on the information processing apparatus when the driver software is installed by the installation unit, and a transmission unit adapted to transmit the information collected by the collection unit to the first image processing apparatus.

Accordingly, a second aspect of the present invention provides an image processing apparatus including a receiving unit adapted to receive information about a first image processing apparatus corresponding to driver software installed on an information processing apparatus from the information processing apparatus, a display unit adapted to display candidates of an image processing apparatus that will substitute a process currently executed by the image processing apparatus based on the information received by the receiving unit, and an acceptance unit adapted to accept a selection by a user from among the candidates displayed by the display unit.

Accordingly, a third aspect of the present invention provides a control method for an information processing apparatus, comprising an installation step of installing driver software corresponding to a first image processing apparatus on the information processing apparatus, a collection step of collecting information about a second image processing apparatus corresponding to another driver software that has been already installed on the information processing apparatus when driver software is installed in the installation step, and a transmission step of transmitting the information collected in the collection step to the first image processing apparatus.

Accordingly, a fourth aspect of the present invention provides a control method for an image processing apparatus, comprising a receiving step of receiving information about a first image processing apparatus corresponding to driver software installed on an information processing apparatus from the information processing apparatus, a display step of displaying candidates of an image processing apparatus that will substitute a process currently executed by the image processing apparatus based on the information received in the receiving step, and an acceptance step of accepting a selection by a user from among the candidates displayed in the display step.

Accordingly, a fifth aspect of the present invention provides a computer-readable storage medium storing a control program executing a control method for an information processing apparatus, the control method comprising an installation step of installing driver software corresponding to a first image processing apparatus on the information processing apparatus, a collection step of collecting information about a second image processing apparatus corresponding to another driver software that has been already installed on the information processing apparatus when driver software is installed in the installation step, and a transmission step of transmitting the information collected in the collection step to the first image processing apparatus.

Accordingly, a sixth aspect of the present invention provides a computer-readable storage medium storing a control program executing a control method for an image processing apparatus, the control method comprising a receiving step of receiving information about a first image processing apparatus corresponding to driver software installed on an information processing apparatus from the information processing apparatus, a display step of displaying candidates of an image processing apparatus that will substitute a process currently executed by the image processing apparatus based on the information received in the receiving step, and an acceptance step of accepting a selection by a user from among the candidates displayed in the display step.

According to the present invention, a setup of alternative apparatus (image processing apparatus) can be made easy when executing an alternative print function.

The features and advantages of the invention will become more apparent from the following detailed description taken in conjunction with the accompanying drawings.

### BRIEF DESCRIPTION OF THE DRAWINGS

FIG. 1 is a block diagram of a network system in which an information processing apparatus and an image processing apparatus according to a first embodiment of the present invention are connected through a network.

FIG. 2 is a block diagram of a host PC in FIG. 1.

FIG. 3 is a flowchart showing procedures of a driver software installation process and a process of driver software that are executed at a host PC side in FIG. 1, and a procedure of an alternative printer setting process that is executed at an MFP side in FIG. 1.

FIG. 4 is a view showing an example of a list table created in step S311 in FIG. 3.

FIG. 5 is a conceptual view of a network system in which an information processing apparatus and an image processing apparatus according to a second embodiment of the present invention are connected through a network.

FIG. 6 is a view showing an example of a list table of the network system in FIG. 5.

### DESCRIPTION OF THE PREFERRED EMBODIMENTS

Hereafter, embodiments according to the present invention will be described in detail with reference to the drawings.

### First Embodiment

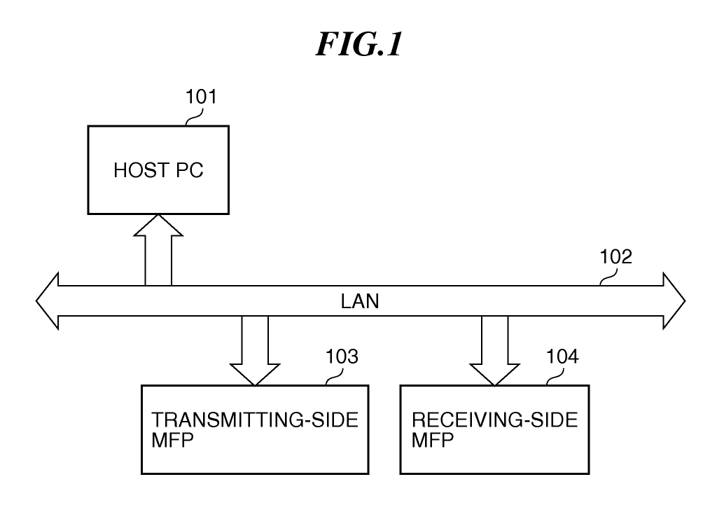

FIG. 1 is a block diagram of a network system in which an information processing apparatus and an image processing apparatus according to a first embodiment of the present invention are connected through a network.

In FIG. 1, the network system is constructed by connecting a host PC 101, a transmitting-side MFP 103, and a receiving-side MFP 104 with a LAN (a network) 102. The host PC 101 acts as an information processing apparatus. The MFPs 103 and 104 act as image processing apparatuses (image output apparatuses).

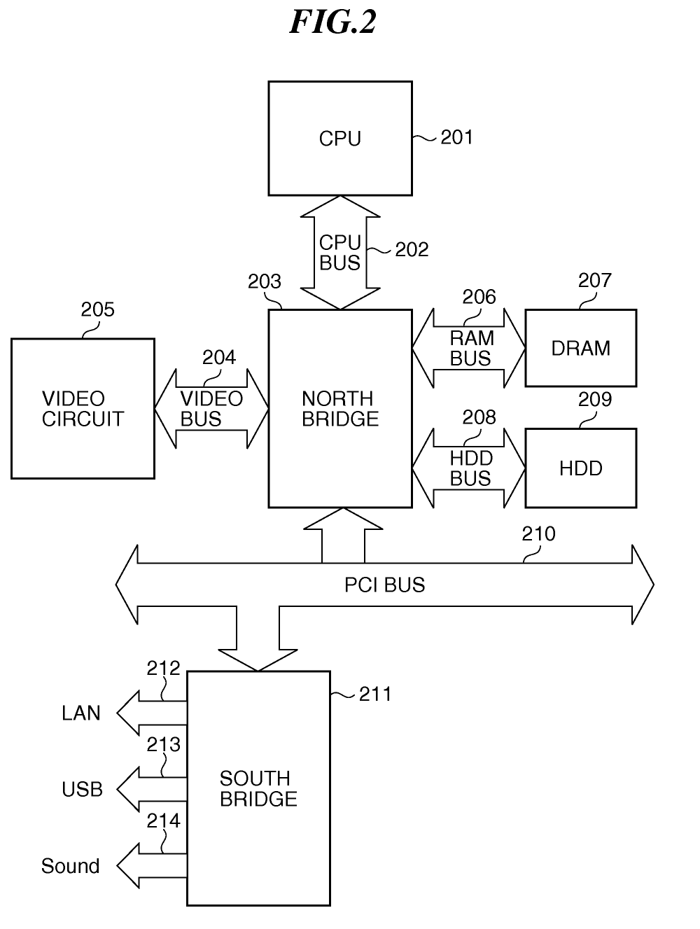

FIG. 2 is a block diagram of the host PC in FIG. 1.

In FIG. 2, a CPU 201 is arranged in the host PC 101. The CPU 201 controls operations of the host PC 101 and executes an operating system (OS) and application programs under OS management. The CPU 201 alone does not function as a PC.

The CPU 201 is connected to a north bridge 203 through a CPU bus 202. The north bridge 203 controls operations of a DRAM 207, a video circuit 205 and the like that require high speed among operations of the host PC 101.

Accordingly, the CPU bus 202 that connects the CPU 201 to the north bridge 203 is designed as a high speed bus. The video circuit 205 is connected to the north bridge 203 through a video bus 204.

The DRAM 207 is connected to the north bridge 203 through a RAM bus 206b, and an HDD 209 is connected to the north bridge 203 through an HDD bus 208. Further, the north bridge 203 is connected to a PCI bus 210 that is a general purpose bus.

The PCI bus 210 is a bus to which a general purpose extended device is connected, and a south bridge 211 that mainly manages an external interface function in the host PC 101 is also connected to the PCI bus 210.

The south bridge 211 includes a LAN control circuit for connecting to a network, a USB control circuit, a sound circuit for synthesizing voice and the like. Further, the south bridge 211 exchanges data with external devices of the host PC 101 through a LAN interface 212, a USB interface 213, and a sound output interface 204, respectively.

The host PC 101 executes a program as follows.

The capacity of the DRAM 207 is insufficient for developing the OS and all of the application programs.

The OS and the application programs are stored in the HDD 209. When executing a program, it is developed from the HDD 209 to DRAM 207 and the developed program is executed by the CPU 201.

To use the MFPs 103 and 104 connected to the network such as the LAN 102 by the OS on the host PC 101, it is necessary to install a software driver on the OS.

In the case of an OS such as the Windows (registered trademark) XP, when new hardware is installed on an interface of the host PC 101, the plug-and-play function of the OS operates.

And a driver suitable for the hardware is loaded from the HDD 209 or an external removable media into the system, and the loaded driver is installed on the OS.

Here, when external hardware is connected through the LAN 102, it cannot be determined whether the hardware is prepared for the host PC 101 or for another host PC that is connected to the LAN 102. Therefore, in such a case, an automatic installation of the driver software by the plug-and-play function is not executed.

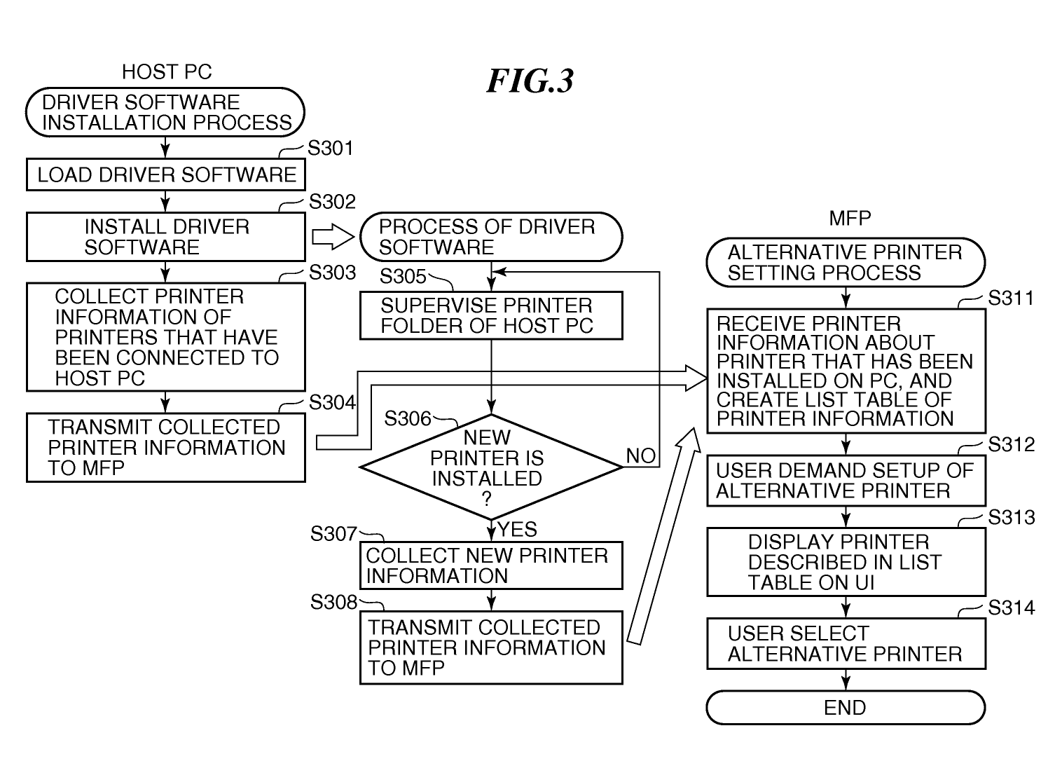

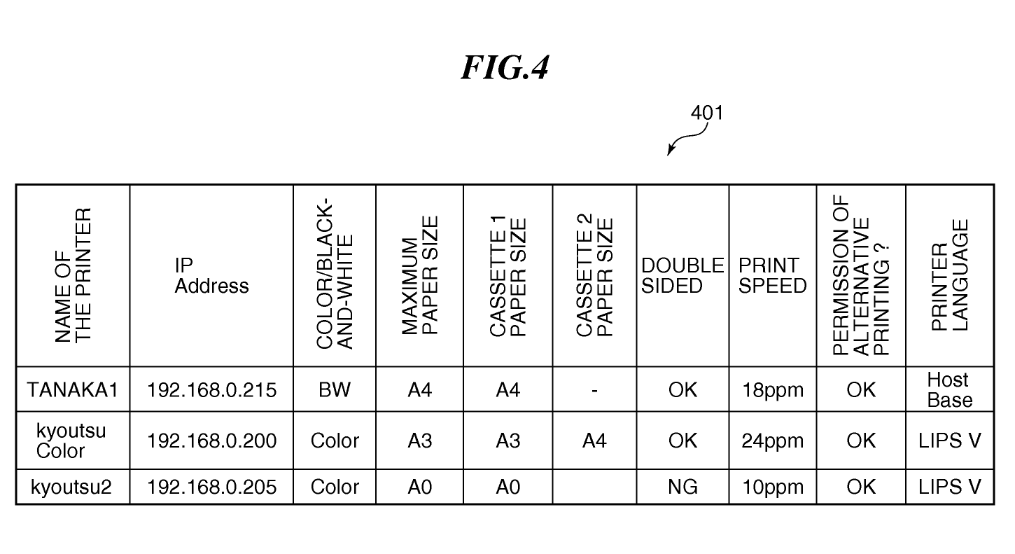

FIG. 3 is a flowchart showing procedures of a driver software installation process and a process of driver software that are executed at the host PC side in FIG. 1, and a procedure of an alternative printer setting process that is executed at the MFP side in FIG. 1.

FIG. 3 shows a case where the transmitting-side MFP 103 for an alternative printing is connected to the LAN interface 212 of the host PC 101.

For the LAN interface 212, the plug-and-play function due to a connection of external hardware is not performed as mentioned above. An installation of the driver of the transmitting-side MFP 103 starts in response to a user's operation to the OS of the host PC 101.

In FIG. 3, when the driver installation process starts, the OS loads adapted driver software from the HDD 209 or an external removable media in step S301.

Next, the OS additionally installs the loaded driver software on itself in step S302. The additionally installed driver software is executed as a part of the OS in parallel with operations of the regular programs (a process of the driver software).

Next, printer information about other printers (MFPs) that have been connected to the host PC 101 through the LAN is collected in step S303 in the driver software installation process.

The printer information includes identification information (a device name, etc.) for identifying a printer, and function information (the presence or absence of a color printing function, resolution, paper-size information, the presence or absence of a staple function, the presence or absence of a double-side printing function, a print speed, etc.) for indicating functions of a printer. The printer information also includes an address (an IP address, a MAC address, etc.) to identify a printer on a network.

Next, when the printer searched in step S303 can perform an alternative printing instead of the MFP 103, the OS transmits the list of the searched printer information to the MFP 103 through the LAN 102 in step S304.

In the process of the driver software, the printer setting folder prepared for the OS of the host PC 101 is supervised in step S305.

Next, in step S306, it is determined whether a new printer has been installed. If a new printer is not found, the process returns to step S305.

If a new printer is found in step S306, the process proceeds to step S307 and the printer information of the new printer is collected.

When the new printer found in step S306 can perform an alternative printing instead of the transmitting-side MFP 103, the driver software transmits the printer information of the new printer to the transmitting-side MFP 103 through the LAN 102.

The transmitting-side MFP 103 performs the alternative printer setting process while referring to the printer information, which has been transmitted from the host PC 101, about the printer that can perform an alternative printing. The alternative printer setting process is executed before an alternative printing is actually performed. Further, the alternative printer setting process is executed as a background process under the normal operation of the transmitting-side MFP 103.

In step S311, the MFP receives the printer information, which has been transmitted from the host PC in steps S304 and S308, about the printer that has been installed on the host PC 101 as a printer that can be alternative, and the MFP creates a list table of the printer information.

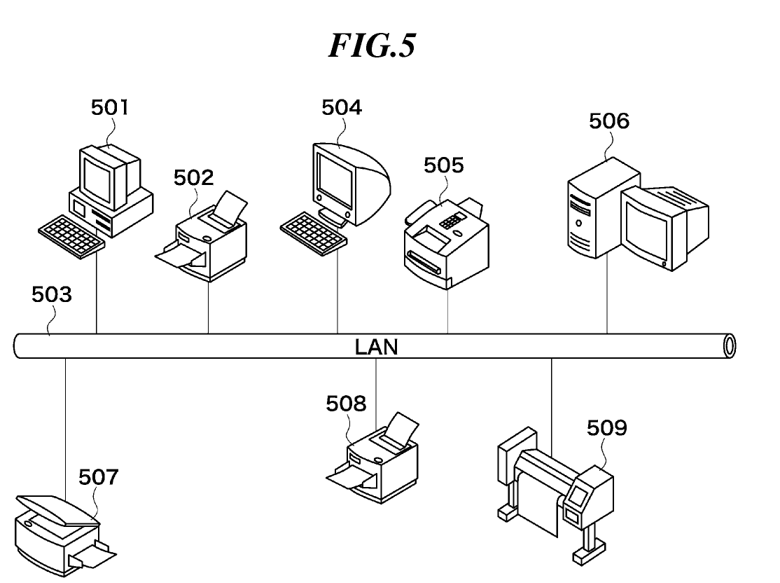

FIG. 4 is a view showing an example of the list table created in step S311 in FIG. 3.

In the list table 401, a unique name of the printer, an IP address, color/black-and-white, a maximum paper size, a cassette paper size, double sided/single sided, a print speed, permission/no-permission of the alternative printing, and a printer language are recorded for each printer.

In FIG. 3, a user of the transmitting-side MFP 103 demands a setup of an alternative printer in step S312. In step S313, the transmitting-side MFP 103 sorts out printers that are described in the list table and permit the alternative printing, and displays them on the UI.

Next, when the user of the transmitting-side MFP 103 selects an alternative printer from the alternative printer candidates displayed on the UT in step S314, the MFP 103 accepts the selection. Then, the image processing apparatus, which is selected as an alternative printer, alternatively executes the process that has been running on the MFP 103. It should be noted that the process in step S311 includes a function of a receiving unit to receive information about a first image processing apparatus corresponding to driver software installed on an information processing apparatus from the information processing apparatus. The process in step S313 is equivalent to a function of a display unit that displays the candidates of an image processing apparatus that will substitute the process currently executed by the image processing apparatus based on the information received by the receiving unit. The process in step S314 is equivalent to a function of an acceptance unit that accepts the selection by a user from among the candidates displayed by the display unit.

As explained above, this embodiment can save a user from checking and inputting an IP address and the like of an alternative printer when a user registers an alternative printer to an MFP. Since the UI does not merely displays a list of alternate printer candidates on a network but printers whose drivers are installed on the host PC, a user can select an alternative printer from pre-narrowed candidates.

Here, the CPU 201 functions as an installation unit that installs driver software corresponding to a first image processing apparatus. The CPU 201 functions as a collection unit that collects information about a second image processing apparatus corresponding to other driver software that has been already installed on an information processing apparatus when the driver software is installed by the installation unit.

And the CPU 201 functions as a transmission unit which transmits the information collected by the collection unit to a first image processing apparatus.

And the CPU 201 functions as a determination unit that determines whether driver software corresponding to a third image processing apparatus has been installed. And the CPU 201 functions as a second collection unit that collects information about the third image processing apparatus, when the determination unit determines that the driver software corresponding to the third image processing apparatus has been installed. Furthermore, the CPU 201 functions as a second transmission unit that transmits the information collected by the second collection unit to the first image processing apparatus.

### Second Embodiment

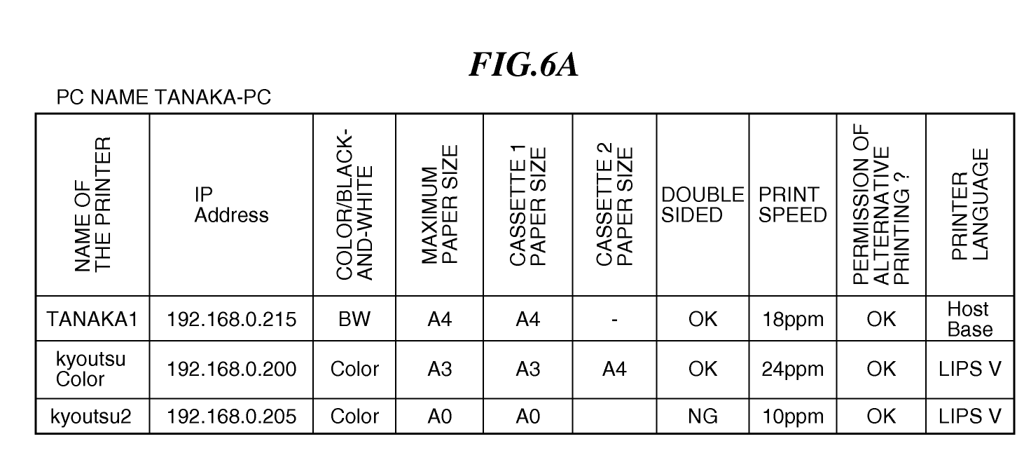

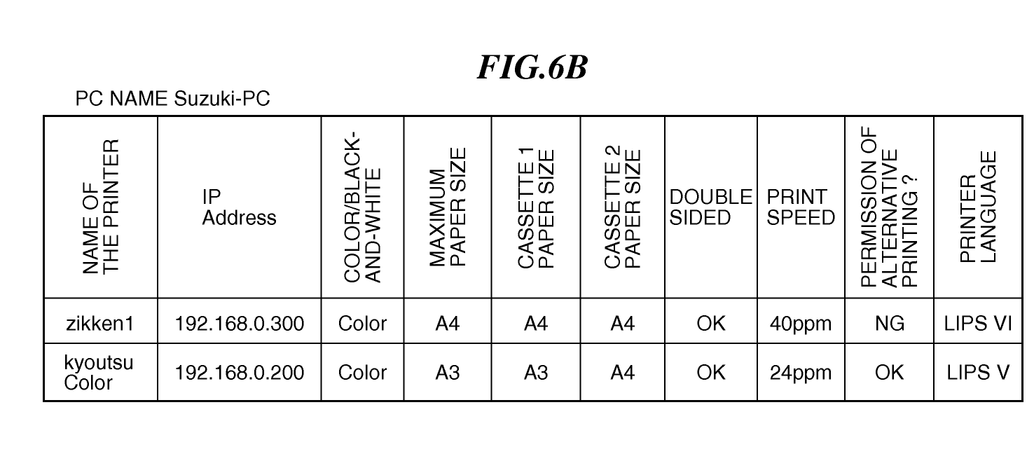

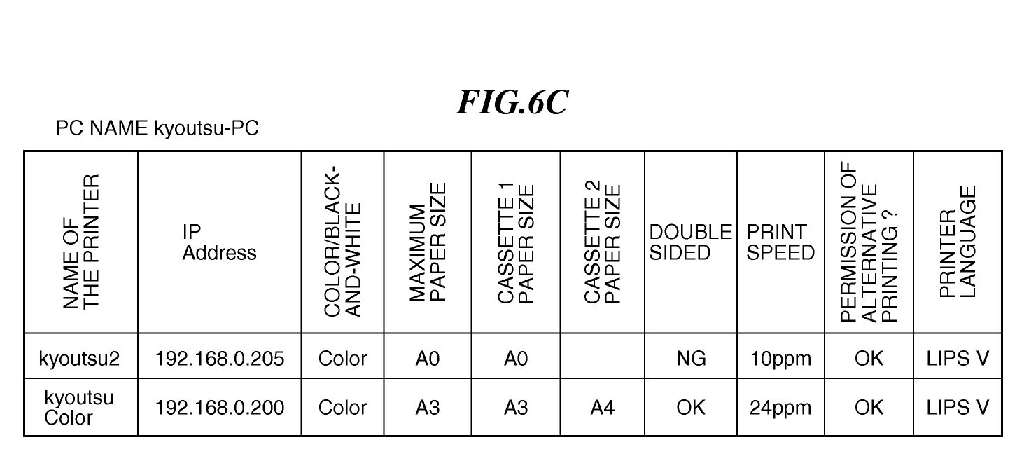

FIG. 5 is a conceptual view of a network system in which an information processing apparatus and an image processing apparatus according to a second embodiment of the present invention are connected through a network. FIG. 6 is a view showing an example of a list table of the network system in FIG. 5.

In FIG. 5, a PC 501 (TANAKA-PC) as an information processing apparatus and a printer 502 (TANAKA1) as an image processing apparatus are arranged close to each other. And a printer driver of the printer 502 is installed on the PC 501. Both of the PC 501 and the printer 502 are connected to a LAN 503.

Since the printer 502 is connected to the LAN 503 but is arranged close to the PC 501, the printer 502 mainly performs a printing job from the PC 501.

A PC 504 (Suzuki PC) as an information processing apparatus and a printer 505 (zikken1) as an image processing apparatus are arranged close to each other and are connected to the LAN 503. And a printer driver of the printer 505 is installed on the PC 504. A PC 506 (Kyoutsu PC) as an information processing apparatus is also connected to the LAN 503.

An MFP 507 (Kyoutsu1) is connected to the LAN 503 as a shared MFP. A printer 508 (Kyoutsu2) and a printer 509 (KyoutsuColor) are connected to the LAN 503 as shared printers.

All the PC 501, PC 504, and PC 506 have a function to transmit printer information as with the host PC 101 in the first embodiment. A printer driver of the printer 508 is installed on the PC 501 and the PC 506. A printer driver of the printer 509 is installed on the PC 501, the PC 504, and the PC 506. A printer driver of the MFP 507 is not installed on any PCs.

Accordingly, connection printer information about the PC 501, the PC 504, and the PC 506 is collected by the MFPs and the printers, respectively. In this embodiment, each of the MFPs and printers has the respective printer information lists for the PC 501, the PC 504, and the PC 506 independently inside itself.

FIG. 6A, FIG. 6B, and FIG. 6C show examples of the printer information lists that are included inside the PC 501, the PC 504, and the PC 506, respectively.

In this embodiment, when an MFP or a printer performs alternative printing, a printer list for alternative printing can be changed according to selection of a PC from among the PC 501, the PC 504, or the PC 506, on the UI of an MFP or a printer.

For example, when the PC 501 is selected on the UI of the MFP 507, the three printers “TANAKA1”, “KyoutsuColor”, and “Kyoutsu2” are displayed according to the printer list of FIG. 6A. A user can select the printer for alternative printing from them.

When the PC 502 is selected on the UI of the MFP 507, the two printers “Zikken1” and “KyoutsuColor” are displayed according to the printer list of FIG. 6B. A user can select the printer for alternative printing from them.

That is, in this embodiment, the printer lists are registered into an image processing apparatus in relation to the respective host PCs. This is a function of a registration unit that registers the information received by the receiving unit in relation to the information processing apparatus that has transmitted the information concerned. Therefore, if a host PC is selected in an image processing apparatus, the printer list related to the host PC will be displayed.

As explained above, this embodiment can save a user from checking and inputting an IP address and the like of an alternative printer when a user registers an alternative printer to an MFP. Since a selection of a host PC causes displaying printers of which drivers are installed on the selected host PC as candidates of an alternative printer, a user can select an alternative printer from among printers that are usually used. The selection of a host PC is a function of a selection unit that selects an information processing apparatus in an image processing apparatus. The display of candidates is a function of the display unit that displays the candidates of an image processing apparatus based on the information registered in relation to the information processing apparatus selected by the selection unit.

### Other Embodiments

The present invention may also be accomplished by supplying a system or an apparatus with a storage medium in which a program code of software which realizes the flow charts of the above described embodiments is stored, and causing a computer (or CPU or MPU) of the system or apparatus to read out and execute the program code stored in the storage medium.

In this case, the program code itself read from the storage medium realizes the functions of any of the embodiments described above, and hence the program code and the storage medium in which the program code is stored constitute the present invention.

Examples of the storage medium for supplying the program code include a floppy (registered trademark) disk, a hard disk, an optical disk, a magnetic-optical disk, a CD-ROM, a CD-R, a DVD-ROM, a magnetic tape, a nonvolatile memory card, a ROM, etc.

While the present invention has been described with reference to exemplary embodiments and it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2008-157861, filed on Jun. 17, 2008, which is hereby incorporated by reference herein in its entirety.

What is claimed is:

1. An information processing apparatus comprising:
an installation unit adapted to install driver software corresponding to a first image processing apparatus on the information processing apparatus;
a collection unit adapted to collect information about a second image processing apparatus corresponding to another driver software that has been already installed on the information processing apparatus when the driver software is installed by said installation unit; and
a transmission unit adapted to transmit the information collected by said collection unit to the first image processing apparatus.

2. The information processing apparatus according to claim 1, further comprising:
a determination unit adapted to determine whether driver software corresponding to a third image processing apparatus has been installed on the information processing apparatus;
a second collection unit adapted to collect information about the third image processing apparatus, when said determination unit determines that the driver software corresponding to the third image processing apparatus has been installed; and
a second transmission unit adapted to transmit the information collected by said second collection unit to the first image processing apparatus.

3. The information processing apparatus according to claim 2, wherein the information collected by said collection unit and said second collection unit includes identification information and function information of an image processing apparatus.

4. An image processing apparatus comprising:
a receiving unit adapted to receive information about a first image processing apparatus corresponding to driver software installed on an information processing apparatus from the information processing apparatus;
a display unit adapted to display candidates of an image processing apparatus that will substitute a process currently executed by the image processing apparatus based on the information received by said receiving unit; and
an acceptance unit adapted to accept a selection by a user from among the candidates displayed by said display unit.

5. The image processing apparatus according to claim 4 further comprising:
a registration unit adapted to register the information received by said receiving unit in relation to the information processing apparatus that has transmitted the information concerned; and
a selection unit adapted to select an information processing apparatus in the image processing apparatus,
wherein said display unit displays the candidates of an image processing apparatus based on the information registered in relation to the information processing apparatus selected by said selection unit.

6. The image processing apparatus according to claim 4, wherein said image processing apparatus is a printer and said driver software is a printer driver.

7. A control method for an information processing apparatus, comprising:
an installation step of installing driver software corresponding to a first image processing apparatus on the information processing apparatus;
a collection step of collecting information about a second image processing apparatus corresponding to another driver software that has been already installed on the information processing apparatus when driver software is installed in said installation step; and
a transmission step of transmitting the information collected in said collection step to the first image processing apparatus.

8. A control method for an image processing apparatus, comprising:
a receiving step of receiving information about a first image processing apparatus corresponding to driver software installed on an information processing apparatus from the information processing apparatus;
a display step of displaying candidates of an image processing apparatus that will substitute a process currently executed by the image processing apparatus based on the information received in said receiving step; and
an acceptance step of accepting a selection by a user from among the candidates displayed in said display step.

9. A computer-readable storage medium storing a control program executing a control method for an information processing apparatus, said control method comprising:
an installation step of installing driver software corresponding to a first image processing apparatus on the information processing apparatus;
a collection step of collecting information about a second image processing apparatus corresponding to another driver software that has been already installed on the information processing apparatus when driver software is installed in said installation step; and
a transmission step of transmitting the information collected in said collection step to the first image processing apparatus.

10. A computer-readable storage medium storing a control program executing a control method for an image processing apparatus, said control method comprising:
a receiving step of receiving information about a first image processing apparatus corresponding to driver software installed on an information processing apparatus from the information processing apparatus;
a display step of displaying candidates of an image processing apparatus that will substitute a process currently executed by the image processing apparatus based on the information received in said receiving step; and
an acceptance step of accepting a selection by a user from among the candidates displayed in said display step.
